(19) United States
(12) Patent Application Publication
(10) Pub. No.: US 2021/0039226 A1
(43) Pub. Date: Feb. 11, 2021

(54) DEVICE FOR PROCESSING A WORKPIECE

(71) Applicant: HAMMELMANN GMBH, Oelde (DE)

(72) Inventors: Christoph BEDNORZ, Beckum (DE); Marc GRÜTER, Rheda-Wiedenbrück (DE); Michael JARCHAU, Oelde (DE)

(21) Appl. No.: 16/966,261

(22) PCT Filed: Jan. 24, 2019
(86) PCT No.: PCT/EP2019/051676

§ 371 Date: Jul. 30, 2020

(30) Foreign Application Priority Data
Jan. 31, 2018 (DE) 10 2018 102 153.4

(51) Int. Cl. B24C 1/08; B24C 7/00

(52) U.S. Cl. CPC B24C 1/083; B24C 7/0023

(57) ABSTRACT

A device for processing a workpiece includes at least one plunger pump, which is drivable by means an electric motor and which generates a highly pressurized volume flow, which volume flow can be interrupted in controlled fashion and emerges from at least one connected consumer. The volume flow is conveyed at substantially constant high pressure via a pressure line to the consumer. The electric motor is a reluctance motor, which is controllable by a connected frequency converter. A pressure sensor is connected to the pressure line, which pressure sensor is connected to a controller.

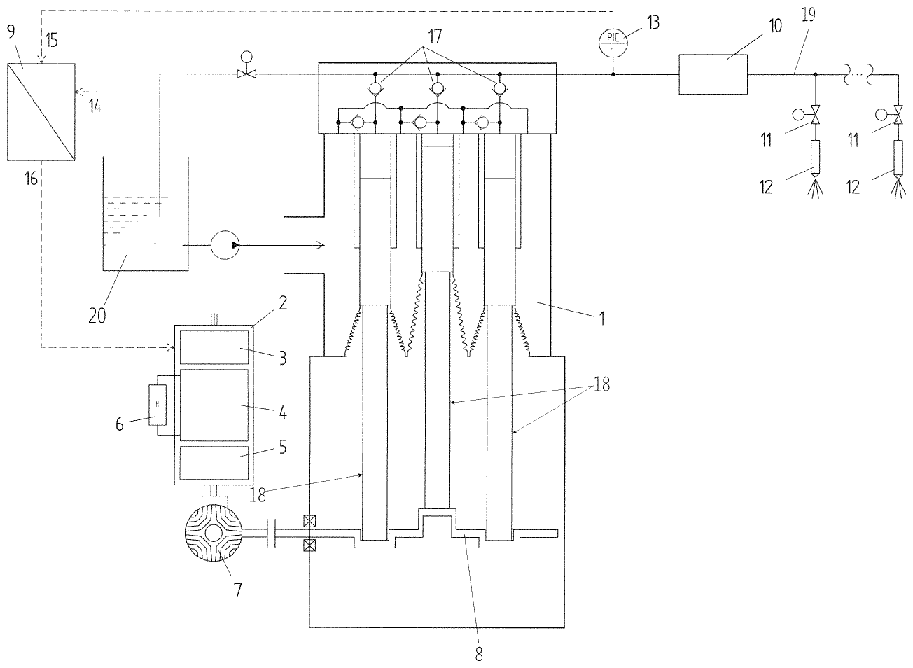

### BACKGROUND AND SUMMARY OF THE INVENTION

Exemplary embodiments of the invention relate to a device for processing a workpiece.

Such devices are well-known. Using them, for example, the surface of a workpiece is processed, for example, roughened or deburred using a fluid pressure of 3000 bar to 4000 bar, as described in EP 1 901 894 B1. Further devices for processing a workpiece are known from AT 515 943 A4 and AT 512 322 B1.

The high-pressure is generated here by a plunger pump, which comprises multiple plungers mounted at equal angle intervals in relation to one another on a crankshaft, to generate a uniform volume flow. The drive of the crankshaft, by which an oscillating movement of the plungers is achieved, is produced by means of an electric motor, typically a three-phase current motor.

It is decisive for the use of the device mentioned as an example that an essentially equal high pressure is available in the pressure line, through which the fluid is guided from the plunger pump to the nozzle, continuously, i.e., both during the operation of the nozzle and also when it is shut off to interrupt the volume flow.

For pressure monitoring, a pressure sensor is arranged in the region of the pressure line, which is operationally connected to the electric motor in such a way that when the fluid exiting from the nozzle is interrupted, i.e., when it is shut off, the electric motor is switched off to shut down the plunger pump, so that the fluid pressure in the pressure line does not rise above the predetermined target pressure. Check valves prevent a backflow of the fluid located in the pressure line after the plunger pump is shut down into its operating chamber.

The electric motor used up to this point, namely the three-phase current motor, meets its limits where short switching cycles are required with regard to its functionality in relation to its switching frequency, i.e., the interruption of the crankshaft.

The power delivery of a three-phase current motor does certainly correspond to the requirements in devices that must provide a relatively large volume flow and/or which comprise multiple plunger pumps arranged in parallel, but providing the required pressure for operating the nozzle is only possible with a delay due to the system, which opposes optimized operation of the device.

Exemplary embodiments of the invention are directed to a device for processing a workpiece with improved functionality with little construction expenditure.

The use according to the invention of a reluctance motor in a device of the type in question results in significant improvements, on the one hand, in the function of the device and, on the other hand, in the processing result. In addition, the operation of the device is now optimized, in particular with respect to the cost-effectiveness.

In this regard, the significantly lower power consumption of the reluctance motor in relation to a three-phase motor is to be mentioned, which is also reduced still further in that, as provided according to a further concept of the invention, the braking energy during the deceleration of the reluctance motor is temporarily stored by an energy accumulator and is provided for its acceleration again upon starting of the reluctance motor.

A further advantage of the reluctance motor is that relatively large rated powers are provided, for example, >300 kW, which are required to operate the device in particular in the areas of use described in the prior art. These include not only use with individual consumers, but rather also with multiple switchable consumers functionally connected to one another.

The mentioned brake resistance, which is connected to the intermediate circuit of a frequency converter, assists with a rapid reduction of the speed of the reluctance motor, which also has an advantageous effect on the operation of the device.

Since the reluctance motor is operable at a very low rated speed, the use of a transmission can be omitted, wherein this rated speed of the reluctance motor corresponds to the drive speed of the plunger pump.

For pressure monitoring and/or for shutting down the reluctance motor, a pressure sensor is arranged in the region of the pressure line, in which essentially the same fluid pressure is continuously available, which pressure sensor detects a pressure increase upon closing of a shutoff valve associated with the consumer, for example, the nozzle, to interrupt the exiting volume flow and initiates the reduction of the speed of the reluctance motor down to the speed zero by deceleration. For this purpose, the pressure sensor is connected to a regulator, which compares an ascertained actual value to a stored target value, so that a closed control loop results.

If the nozzle is shut off and a speed of the reluctance motor is in the range of zero, a minor leak, for example, caused by worn pressure valves of the pump or leaky pipelines, can be recognized as a slow change of the pressure in the pressure line over time, which finally makes possible status monitoring of the facility.

According to a further concept of the invention, a damper is provided, the damper is arranged in the pressure line before the shutoff valve associated with the consumer and after the check valves viewed in the flow direction of the fluid.

With the aid of this damper, a pressure increase as results upon the running on of the reluctance motor after it is switched off, may be compensated for by compression of the fluid enough that this pressure increase is harmless to the participating components.

Inter alia, the relatively low temperature during the operation of the reluctance motor contributes to an optimized service life of the device, since such a motor does not have rotor windings due to its construction and therefore as a result it also does not have rotor power loss, so that a high efficiency results therefrom.

In addition, the susceptibility to failure of the reluctance motor is extremely low, since neither magnets nor cage rotors are components and in addition bearings are protected by the low temperatures.

As mentioned, the novel device is particularly suitable for industrial cleaning, deburring, or roughening processes, wherein corresponding hydraulic tools such as cleaning lances, nozzle systems, or flat jet nozzles can be used. It is to be particularly emphasized that processing using extremely short cycle times, i.e., rapid switching on and off of the volume flow, is possible by means of the invention.

The device according to the invention is particularly suitable for use in a so-called common rail system, in which multiple plunger pumps deliver in a shared pressure line, to which a plurality of consumers, in particular nozzles, are connected, wherein the plunger pumps of the system are operated by means of at least one reluctance motor.

The invention also relates to a method for operating a device for processing a workpiece. Accordingly, with the aid of a known present speed of the plunger pump, the delivered volume flow is continuously compared to the volume flow or sum volume flow taken by the consumer or consumers and a deviation from a target value is signaled, for example, visually and/or acoustically, or the reluctance motor and thus the plunger pump are switched off.

Leak monitoring of the device is possible with the aid of this method. This is because the fluid pressure in the pressure line drops in the event of a leak during operation of the device, which is detected by the pressure sensor. As a result, the volume flow available to the consumer is reduced. To keep the pressure in the pressure line at a target dimension, the speed of the plunger pump was increased accordingly. The difference between the known volume flow delivered by the consumer and the higher delivered volume flow due to the speed increase of the plunger pump is an indication of a leak, which is detected quasi-directly and results in the mentioned signaling or shutdown of the reluctance motor. Damage to the device or other participating components is thus prevented, as are power losses, which result during further operation of the device without leak detection.

### BRIEF DESCRIPTION OF THE DRAWING FIGURE

One exemplary embodiment of the invention is described hereafter on the basis of the appended drawing.

The single FIGURE shows the conceptual structure of the device according to the invention in a block diagram.

### DETAILED DESCRIPTION

A device for processing a workpiece is depicted in the FIGURE, having a plunger pump 1, which comprises three plungers 18 in the example, which are mounted on a crankshaft 8, preferably offset by 120° in relation to one another, and are drivable in an oscillating manner by means of an electric motor connected to the crankshaft 8.

The electric motor is designed as a reluctance motor 7 according to the invention and is connected to a frequency converter 2 comprising a rectifier 3, a DC intermediate circuit 4, and an inverter 5.

A brake resistance 6 is connected to the DC intermediate circuit 4 of the frequency converter 2, which effectuates a rapid reduction of the speed of the crankshaft 8 upon shutdown of the reluctance motor 7.

On the suction side, the plungers 18 are connected to a fluid accumulator 20, while the fluid, which is under a high pressure after a work cycle of the plungers 18, is supplied via a pressure line 19 in the example to two consumers 12 in the form of a nozzle, wherein a check valve 17 is arranged between the pressure line 19 and the respective plunger 18.

The pressure line 19 is closed via shutoff valves 11 to interrupt the volume flow from the consumers 12, wherein the fluid pressure in the pressure line 19 rises immediately.

This pressure increase is ascertained via a pressure sensor 13 in the pressure line 19, to which a regulator 9 is connected, in which a target value 14 is compared to an actual value 15 recognized via the pressure sensor 13 and as an actuating value 16, the reluctance motor 7 is throttled via the frequency converter 2 in its speed down to a standstill, using the brake resistance 6.

During this time, the pressure is maintained in the pressure line 19, so that the volume flow is immediately available at operating pressure after opening of the shutoff valves 11.

Since in principle the throttling of the speed of the reluctance motor 7 occurs delayed by a certain time span after closing of the pressure line 19 via the shutoff valves 11, the pressure rises further in the pressure line 19.

To prevent components subjected thereto from being damaged, a damper 10 is integrated upstream from the shutoff valves 11 in the pressure line 19, by means of which the available higher pressure is absorbed by compression of the fluid.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

1 plunger pump
2 frequency converter
3 rectifier
4 DC intermediate circuit
5 inverter
6 brake resistance
7 reluctance motor
8 crankshaft
9 regulator
10 damper
11 shutoff valve
12 consumer
13 pressure sensor
14 target value
15 actual value
16 actuating value
17 check valve
18 plunger
19 pressure line
20 fluid accumulator

1-5. (canceled)

6. A device for processing a workpiece, the device comprising:
an electric motor;
at least one plunger pump coupled to the electric motor so that the at least one plunger pump generates a volume flow under a high pressure that can be interrupted in a controlled manner and that exits from at least one connected consumer; and
a pressure line coupled to the at least one plunger pump, wherein the volume flow is delivered to the consumer via the pressure line under substantially uniform high pressure,
wherein the electric motor is a reluctance motor, which is controllable via a connected frequency converter, and
wherein a pressure sensor, which is connected to a regulator, is connected to the pressure line.

7. The device of claim 6, wherein the frequency converter includes a DC intermediate circuit, which is connected to a brake resistance.

8. The device of claim 6, further comprising:
a damper arranged in the pressure line for damping a fluid pressure, which increases after a shutdown of the at least one plunger pump.

9. The device of claim 6, further comprising:
a capacitive energy accumulator operationally connected to the reluctance motor via the frequency converter to store braking energy.

10. A method for operating a device for processing a workpiece, wherein the device comprises an electric motor, at least one plunger pump coupled to the electric motor so that the at least one plunger pump generates a volume flow under a high pressure that can be interrupted in a controlled manner and that exits from at least one connected consumer, and a pressure line coupled to the at least one plunger pump, wherein the volume flow is delivered to the consumer via the pressure line under substantially uniform high pressure, wherein the electric motor is a reluctance motor, which is controllable via a connected frequency converter, and wherein a pressure sensor, which is connected to a regulator, is connected to the pressure line, the method comprising:
comparing the delivered volume flow is compared to a volume flow taken by the consumer based on a predetermined speed of the plunger pump,
wherein in the event of a deviation of the delivered volume flow from a target value, a signal is provided or the reluctance motor and thus the plunger pump are shut down.
